(19) United States
(12) Patent Application Publication
(10) Pub. No.: US 2018/0154507 A1
(43) Pub. Date: Jun. 7, 2018

(54) HAND-HELD POWER TOOL INCLUDING A SPRING DETENT MECHANISM

(71) Applicant: Robert Bosch GmbH, Stuttgart (DE)

(72) Inventor: Heiko Roehm, Stuttgart (DE)

(21) Appl. No.: 15/812,366

(22) Filed: Nov. 14, 2017

(30) Foreign Application Priority Data
Dec. 6, 2016 (DE) 102016224245.8

(51) Int. Cl. B25F 5/00; B23B 45/02

(52) U.S. Cl. CPC B25F 5/001; B25B 23/147; B23B 45/02; B25F 5/008

(57) ABSTRACT

A hand-held power tool including a tool housing in which a drive motor is situated for driving a drive spindle provided with a tool holder, the tool holder being designed for accommodating an insertion tool, and including a spring detent mechanism which is assigned to the drive spindle and includes at least one spring element, the at least one spring element being compressible, in at least one operating mode of the hand-held power tool, at least in phases, with the aid of energy of the drive motor, a fan wheel is provided, which is provided at least for cooling the drive motor, at least 20 percent by volume of the fan wheel including a metal having a density which is greater than or equal to 3.5 g/cm³.

### CROSS REFERENCE

The present application claims the benefit under 35 U.S.C. § 119 of German Patent Application No. DE 102016224245.8 filed on Dec. 6, 2016, which is expressly incorporated herein by reference in its entirety.

### BACKGROUND INFORMATION

The present invention relates to a hand-held power tool including a tool housing in which a drive motor is situated for driving a drive spindle provided with a tool holder, the tool holder being designed for accommodating an insertion tool, and including a spring detent mechanism which is assigned to the drive spindle and includes at least one spring element, the at least one spring element being compressible, in at least one operating mode of the hand-held power tool, at least in phases, with the aid of energy of the drive motor.

Such a hand-held power tool including a drive motor—for driving a drive spindle—situated in a tool housing is conventional. In this case, a tool holder for accommodating an insertion tool is assigned to the drive spindle. Moreover, a spring detent mechanism is assigned to the drive spindle. The spring detent mechanism includes one or multiple spring elements, the spring element or spring elements being compressible, in at least one operating mode of the hand-held power tool, at least in phases, with the aid of energy of the drive motor. In addition, a fan wheel, which is usually made of plastic, may be provided for cooling the drive motor.

### SUMMARY

The present invention relates to a hand-held power tool including a tool housing in which a drive motor is situated for driving a drive spindle provided with a tool holder, the tool holder being designed for accommodating an insertion tool, and including a spring detent mechanism which is assigned to the drive spindle and includes at least one spring element, the at least one spring element being compressible, in at least one operating mode of the hand-held power tool, at least in phases, with the aid of energy of the drive motor. A fan wheel is provided, which is intended at least for cooling the drive motor, at least 20 percent by volume of the fan wheel including a metal having a density which is greater than or equal to 3.5 g/cm³.

The present invention therefore makes it possible to provide a hand-held power tool which includes a fan wheel, in the case of which an increase in an appropriate inertia of the fan wheel may be effectuated by way of the formation of the fan wheel having at least 20 percent by volume of metal and, as a result, a reduction of a speed drop occurring in the at least one operating mode, in which the at least one spring element is compressible at least in phases, is at least approximately made possible. Therefore, it may be made possible to provide a safe and reliable hand-held power tool.

The fan wheel preferably includes zinc, a zinc alloy, brass, and/or steel. A cost-effective and robust fan wheel may therefore be provided.

The fan wheel preferably includes a flange for forming a force-locked connection with a drive shaft assigned to the drive motor. A safe and reliable drive of the fan wheel may therefore be made possible.

According to one specific embodiment, the fan wheel includes a composite material which includes at least plastic or two different metals. The at least 20 percent by volume of the fan wheel including metal may therefore be formed in a simple way.

A gear unit is preferably situated between the drive motor and the tool holder, the gear unit being designed in the manner of a planetary gear set and includes at least one planetary stage. A stable and robust gear unit may therefore be provided in a simple way.

The at least one planetary stage preferably includes at least one sun wheel and one ring gear, the sun wheel being movable in the radial direction of the gear unit by at least 0.2 mm relative to the ring gear. The gear unit may therefore be installed in a simple and uncomplicated way.

The spring detent mechanism is preferably situated between the gear unit and the tool holder. A space-saving and efficient arrangement of the spring detent mechanism may therefore be made possible.

The spring detent mechanism is preferably designed in the manner of a torque clutch or a rotary impact mechanism. A torque clutch or a rotary impact mechanism may therefore be provided in a simple way.

The drive motor is preferably designed in the manner of an electronically commutated drive motor including a stator and a rotor provided with at least one permanent magnet. A safe and reliable drive motor may therefore be provided.

According to one specific embodiment, the fan wheel has an outer diameter which is greater than or equal to an outer diameter of the drive motor. An efficient cooling of the drive motor may therefore be made possible in a simple way.

The hand-held power tool is preferably designed in the manner of a combi drill or a rotary impact screwdriver. A combi drill or a rotary impact screwdriver may therefore be provided with an efficient cooling of an appropriate drive motor in a simple way.

### BRIEF DESCRIPTION OF THE DRAWINGS

The present invention is described in greater detail below, with reference to exemplary embodiments shown in the figures.

FIG. 1 shows a schematic view of a hand-held power tool according to the present invention.

FIG. 2 shows a side view of the hand-held power tool from FIG. 1 including an opened tool housing.

FIG. 3 shows a sectional view of a cut-through 300 of the hand-held power tool from FIG. 1.

FIG. 4 shows an exploded view of a spring detent mechanism assigned to the hand-held power tool from FIG. 1.

FIG. 5 shows a perspective view of a drive motor assigned to the hand-held power tool from FIG. 1, and of a fan wheel.

FIG. 6 shows a sectional view of the drive motor and of the fan wheel from FIG. 5.

FIG. 7 shows a side view of the hand-held power tool from FIG. 1 having an opened tool housing and including a spring detent mechanism according to yet another specific embodiment.

### DETAILED DESCRIPTION OF EXAMPLE EMBODIMENTS

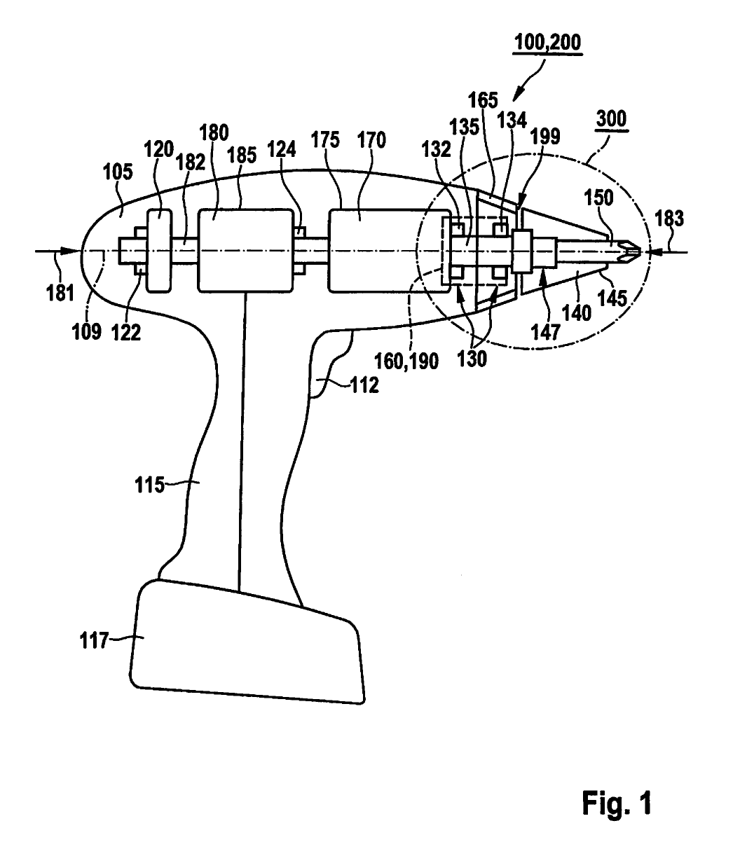

FIG. 1 shows a hand-held power tool 100 which includes a tool housing 105 by way of example. As demonstrated, tool housing 105 is designed in the shape of a pistol and preferably includes a handle 115. Preferably, at least one drive motor 180 including a drive shaft 182 for driving a drive spindle 135 connected to a tool holder 140 is situated in tool housing 105. A spring detent mechanism 160 is preferably assigned to drive spindle 135.

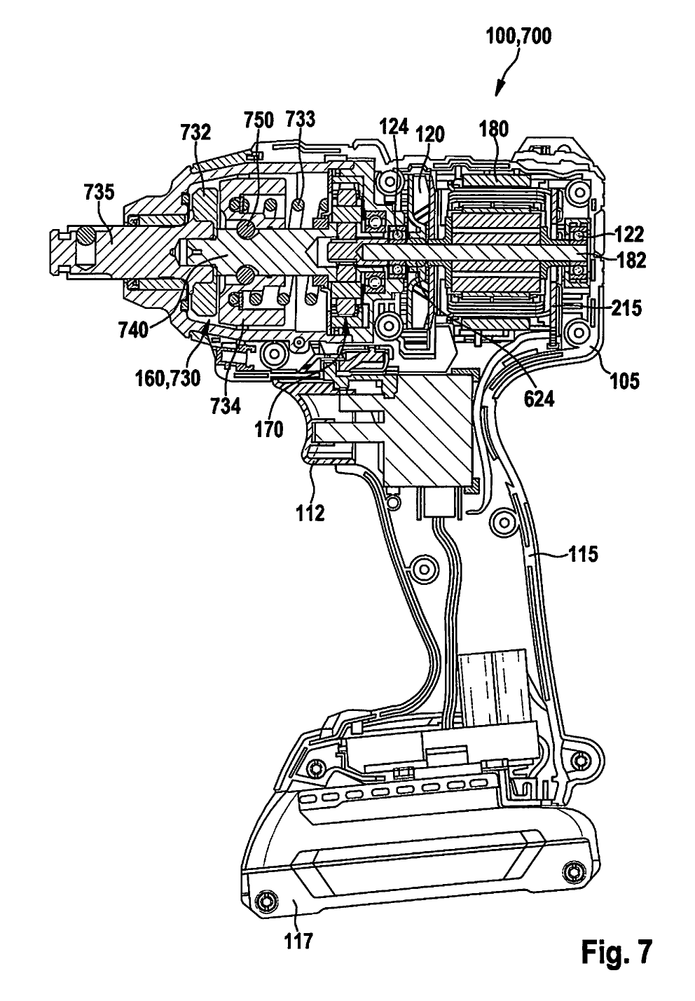

According to one specific embodiment, hand-held power tool 100 is designed in the manner of a hand-guided power tool and is mechanically and electrically connectable to a rechargeable battery pack 117 for a cordless power supply. In FIG. 1, hand-held power tool 100 is designed as a cordless combi drill 200, by way of example, and, in FIG. 7, hand-held power tool 100 is designed as a rotary impact screwdriver (700 in FIG. 7), by way of example. It is pointed out, however, that the present invention is not limited to hand-guided power tools and, in particular, to cordless combi drills and/or cordless rotary impact screwdrivers, but rather may be utilized with different hand-held power tools which include a drive spindle provided with a spring detent mechanism 160, irrespective of whether these hand-held power tools are battery-operated or mains-operated.

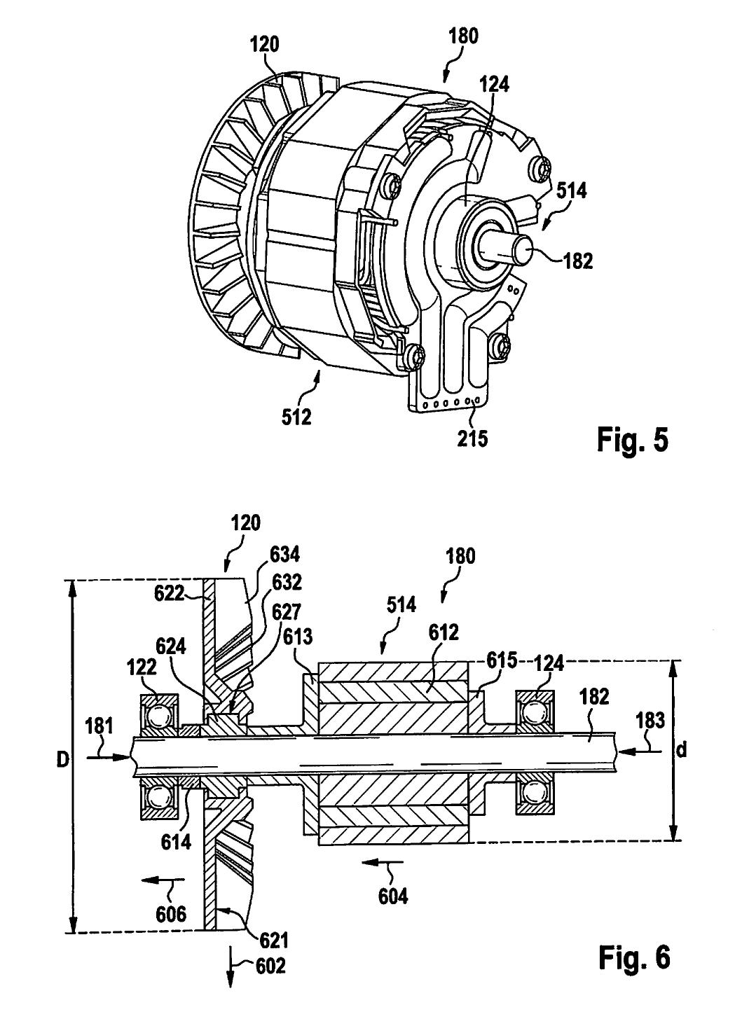

In hand-held power tool 100, rechargeable battery pack 117 is preferably utilized for supplying power to drive motor 180 which is designed in the manner of an electric motor, by way of example. The drive motor is actuatable, i.e., switchable on and off, for example via a manual switch 112 preferably situated on handle 115. Drive motor 180 is an electronically commutated motor. Drive motor 180 is preferably designed as a DC motor including a stator (512 in FIG. 5) and a rotor (514 in FIG. 5) provided with at least one permanent magnet (612 in FIG. 6). As demonstrated, drive motor 180 is situated in the area of handle 115 in this case, at least drive motor 180 or drive shaft 182 and drive spindle 135 preferably having a shared longitudinal axis 109 and longitudinal axis 109 being situated at least approximately perpendicularly to handle 115, by way of example.

Drive motor 180 is preferably electronically controllable and regulatable in such a way that a reversing mode as well as inputs related to a desired rotational speed are achievable. The mode of operation and the design of a suitable drive motor are conventional, and therefore a detailed description thereof is dispensed with here for the sake of conciseness of the description.

Drive motor 180 is preferably connected to drive spindle 135 via a gear unit 170 situated in tool housing 105. Preferably, drive motor 180 is situated in a motor housing 185 and gear unit 170 is situated in a gear unit housing 175, gear unit housing 175 and motor housing 185 being situated in tool housing 105, by way of example. Gear unit 170 is preferably situated between drive motor 180 and tool holder 140. In this case, drive shaft 182 is preferably connected to gear unit 170, gear unit 170 being connected to tool holder 140 via drive spindle 135.

Gear unit 170 is preferably designed for transmitting a torque generated by drive motor 180 to drive spindle 135 and, merely by way of example, but not absolutely necessarily, to a planetary gear set which is designed having different gears and planetary stages and which is rotationally driven by drive motor 180 during the operation of hand-held power tool 100. It is pointed out, however, that a provision of gear unit 170 may also be dispensed with, depending on a selected embodiment of drive motor 180.

Drive spindle 135 is preferably rotatably mounted in tool housing 105 with the aid of a bearing assembly 130 and is preferably connected to tool holder 140 which is situated in the area of a front side 199 of tool housing 105, by way of example, and includes a drill chuck 145, by way of example. According to one specific embodiment, bearing assembly 130 includes at least two bearing points 132, 134 which are preferably provided in tool housing 105 in an area situated downstream from gear unit 170. Tool holder 140 is utilized for accommodating an insertion tool 150 and may be integrally formed on drive spindle 135 or connected to the drive spindle in the form of an attachment. In FIG. 1, tool holder 140 is designed to be attachment-like, by way of example, and is fastened to drive spindle 135 by way of a fastening device 147 provided on the drive spindle.

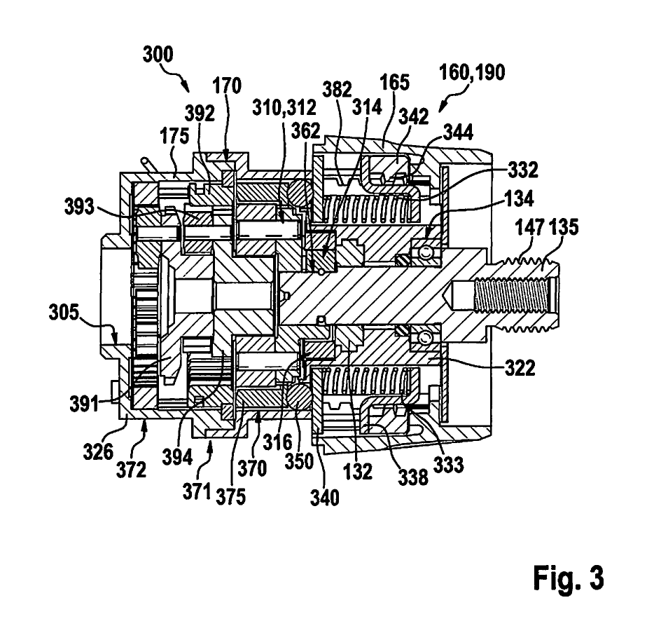

According to one specific embodiment, spring detent mechanism 160, which preferably includes at least one spring element (332, 333 in FIG. 3), is assigned to drive spindle 135 as described above. Preferably, the at least one spring element (332, 333 in FIG. 3) is compressible, in at least one operating mode of hand-held power tool 100, at least in phases, with the aid of energy of drive motor 180. In this case, a spring compression phase, in which the at least one spring element (332, 333 in FIG. 3) is compressed, and a load-free phase preferably alternate. As demonstrated, spring detent mechanism 160 is situated between gear unit 170 and tool holder 140.

According to one specific embodiment, spring detent mechanism 160 is designed in the manner of a torque clutch 190 in FIG. 1, the at least one operating mode preferably being a screwing mode. In addition, according to yet another specific embodiment, as shown in FIG. 7, spring detent mechanism 160 may also be designed in the manner of a rotary impact mechanism (730 in FIG. 7), the at least one operating mode being a rotary impact mode.

Spring detent mechanism 160 designed as a torque clutch 190, by way of example, in FIG. 1 is equipped, as demonstrated, with an operating element 165 which is actuatable by a user of hand-held power tool 100 and is rotatable, in particular. Operating element 165 actuatable by the user is preferably designed for adjusting a, for example, work-specific torque limitation desired by the user in the particular case, with the aid of torque clutch 190, or for adjusting a particular torque level of torque clutch 190, at least within predefined limits. In this case, operating element 165 is designed in the shape of a sleeve, by way of example, and is therefore also referred to in the following as “torque adjustment sleeve” 165. Torque clutch 190 is described in greater detail in the following with reference to the enlarged view of a cut-through 300 of hand-held power tool 100 represented in FIG. 3.

Preferably, at least one fan wheel 120 is provided, which is preferably provided at least for cooling drive motor 180. In this case, at least 20 percent by volume of fan wheel 120 includes a metal having a density which is greater than or equal to 3.5 g/cm³. Fan wheel 120 preferably includes zinc, a zinc alloy, brass, and/or steel. Fan wheel 120 preferably includes a composite material and is preferably made of a composite material which includes at least plastic or two different metals. In this case, fan wheel 120 preferably includes a flange (624 in FIG. 6) for forming a force-locked connection to drive shaft 182.

Due to the above-described fan wheel 120, torque fluctuations of drive motor 180 occurring during an operation of spring detent mechanism 160 or between particular spring-compression phases and corresponding, subsequent, load-free phases may be reduced. As a result, a speed drop in the spring-compression phase may be at least reduced, whereby a relatively simple speed regulation may be made possible.

Moreover, fan wheel 120 has a relatively greater inertia due to the embodiment in which at least 20 percent by volume of fan wheel 120 includes a metal having a density which is greater than or equal to 3.5 g/cm³, whereby a reduction of vibrations and, therefore, an increase in smooth running of hand-held power tool 100 may be made possible. Preferably, fan wheel 120 according to the present invention increases a rotational inertia of drive motor 180 or its rotor (514 in FIG. 5) by preferably at least 5%, more preferably 10%, and particularly preferred by more than 15% as compared to a fan wheel made of plastic. In addition, a lesser reduction of a motor speed of drive motor 180, accompanied by a temporary increase in load resistance, may be made possible. A simple noise suppression of hand-held power tool 100 may also be achieved by way of above-described fan wheel 120.

Drive shaft 182, in this case, is preferably supported in tool housing 105 at an end 181 facing away from tool holder 140 and/or at an end 183 facing tool holder 140 via a bearing element 122, 124, respectively. In this case, drive shaft 182 is preferably designed in the shape of a rod. Fan wheel 120 is preferably situated between the two bearing elements 122, 124.

As demonstrated, fan wheel 120 is situated between bearing element 122 and drive motor 180. As a result, an improved device balance of hand-held power tool 100 may be preferably made possible, since the center of gravity of hand-held power tool 100 is situated in grip area 115.

Fan wheel 120 may also be situated between drive motor 180 and optional gear unit 170, however, as shown in FIG. 7. In this case, fan wheel 120 is preferably utilized as a flywheel mass, whereby a speed drop may be reduced and a safe operation of hand-held power tool 100 may be made possible. Moreover, several fan wheels 120 may also be provided, the fan wheels being situatable at different positions, for example, between a bearing element 122 and drive motor 180 or between drive motor 180 and gear unit 170.

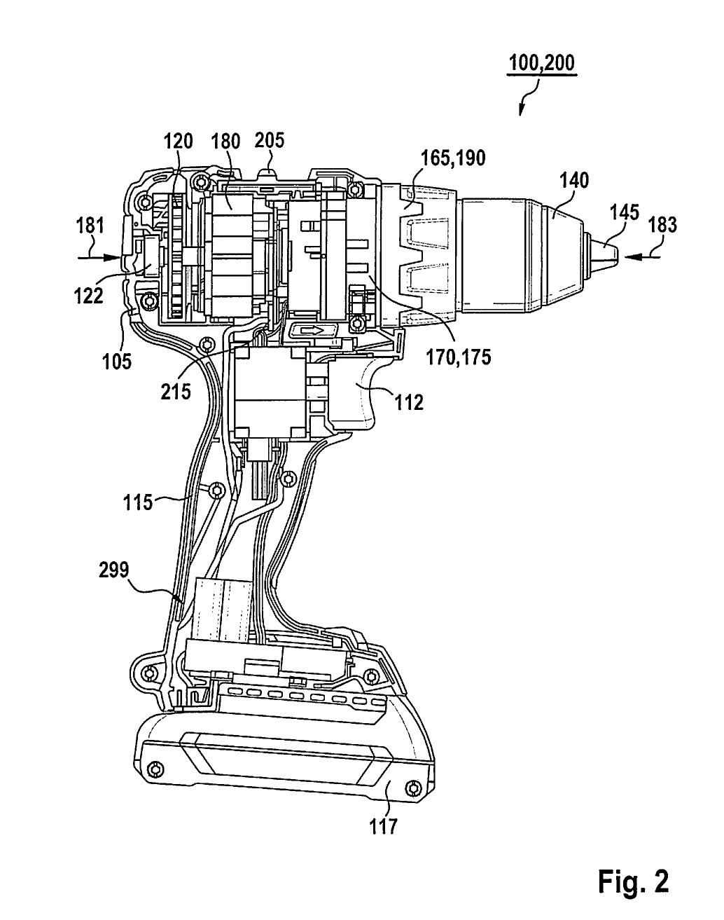

FIG. 2 shows hand-held power tool 100 from FIG. 1 in order to illustrate an exemplary arrangement of bearing element 122 in tool housing 105, and torque adjustment sleeve 165 assigned to spring detent mechanism 160 from FIG. 1 or to torque clutch 190. Moreover, FIG. 2 illustrates a motor electronics system 215 assigned to drive motor 180. In this case, motor electronics system 215 is situated between drive motor 180 and optional gear unit 170, by way of example, although the motor electronics system could also be situated at any other point, for example, between fan wheel 120 and drive motor 180. In addition, FIG. 2 shows an exemplary gear shifter 205 for changing a particular gear ratio of gear unit 170. Moreover, a main electronics system 299 of hand-held power tool 100 is preferably situated in grip area 115 between switch 112 and rechargeable battery pack 117.

FIG. 3 shows a cut-through 300 of hand-held power tool 100 from FIG. 1, in which a representation of insertion tool 150 and tool holder 140 from FIG. 1 has been dispensed with for the sake of clarity and simplicity of the drawing. Cut-through 300 illustrates an exemplary embodiment of gear unit 170 as a planetary gear set, of spring detent mechanism 160 designed as torque clutch 190, and an optional spindle locking device 310.

Gear unit 170, which is preferably designed as a planetary gear set, is preferably switchable at least between a first and a second gear and, by way of example, includes three planetary stages, a front stage 370, a central stage 371, and a rear stage 372. Central planetary stage 371 includes, by way of example, a sun wheel 391 including at least one planet wheel 393, a planet carrier 394 including the sun wheel of next planetary stage 370, and a ring gear 392. In this case, sun wheel 391 is preferably movable in the radial direction of gear unit 170 by at least 0.2 mm relative to ring gear 392. It is pointed out that corresponding sun wheels of the two other planetary stages 370, 372 may also be designed to be radially movable.

During operation, a torque of drive motor 180 from FIG. 1 and FIG. 2 is transmitted to drive spindle 135 via planetary stages 372, 371, 370 with the aid of a rotary driving contour of planet carrier 312. In this case, gear unit housing 175 includes a bearing point 305 for supporting drive shaft 182 from FIG. 1 with the aid of bearing element 124. Since the design of a planetary gear set is conventional, a further description of planetary stages 370, 372 is dispensed with here for the sake of conciseness of the description.

Planetary stages 370, 371, 372 are situated, by way of example, in gear unit housing 175 which is preferably formed as two pieces and, as demonstrated, is subdivided into a front section 322 which is on the right in FIG. 3 and, fastened thereto, a rear section 326 which is on the left in FIG. 3. As demonstrated, planetary stages 371, 372 are situated in rear section 326. Situated in front section 322 is optional spindle locking device 310 which is at least designed to at least essentially prevent a rotation of drive spindle 135 relative to tool housing 105 in the spindle locking mode. In this case, spindle locking device 310 may be triggered during a rotation of drive spindle 135 in an arbitrary direction of rotation or only during a rotation in one predefined direction of rotation. The spindle locking mode makes it possible to open or close tool holder 140 from FIG. 1 and FIG. 2, for example while drive motor 180 from FIG. 1 and FIG. 2 is at a standstill. As demonstrated, a male thread 382, on which, by way of example, torque clutch 190 or torque adjustment sleeve 165 is rotatably mounted, is formed on the outer circumference of front section 322.

Optional spindle locking device 310 is situated, by way of example, between gear unit 170 and torque clutch 190 or tool holder 140 in the axial direction of drive spindle 135, although, as an alternative thereto, the spindle locking device may be situated at another suitable position, for example in gear unit 170 or between gear unit 170 and drive motor 180. Drive spindle 135 preferably includes—on its drive-side axial end or on its end facing drive motor 180—at least one, preferably three clamping surfaces 362 for interaction with spindle locking device 310. The at least one clamping surface 362 may also be formed on a separate component assigned to drive spindle 135, the separate component being coupleable to drive spindle 135.

Moreover, optional spindle locking device 310 preferably includes at least planet carrier 312, a clamping ring 316, and at least one blocking member 314. Blocking members 314 are preferably mounted in clamping ring 316. In this case, clamping ring 316 is preferably designed for preventing blocking members 314 from slipping out of planet carrier 312 in the radial direction of drive spindle 135. Blocking members 314 are preferably clampable, in the spindle locking mode of spindle locking device 310, between clamping ring 316 and a clamping surface 362 of drive spindle 135 assigned to particular blocking member 314. Clamping surface 362 is preferably designed for at least essentially preventing twisting of drive spindle 135 relative to gear unit housing 175 and, therefore, relative to tool housing 105. In this case, blocking members 314 preferably have a cylindrical design, although they may also have any other shape, for example a spherical shape. A suitable spindle locking device for implementing spindle locking device 310 is conventional, and a detailed description thereof is therefore dispensed with for the sake of simplicity and conciseness of the description.

Drive spindle 135 is preferably rotatably mounted in gear unit housing 175 in output-side area 322 with the aid of first and second bearing points 132, 134 as components of bearing assembly 130 from FIG. 1. In this case, first bearing point 132 is designed, by way of example, as a sliding bearing and second bearing point 134 is designed as a ball bearing.

A transmission element 340 is preferably assigned to torque clutch 190 situated on the outer circumference of output-side area 322. Transmission element 340 is preferably at least approximately designed in the shape of a disk. In this case, transmission element 340 is preferably acted upon by at least one and preferably six spring elements 332, 333 in the direction of planetary gear set 170, only two spring elements 332, 333 being represented in FIG. 3. Spring elements 332, 333 are preferably uniformly spaced apart from each other in the circumferential direction of drive spindle 135.

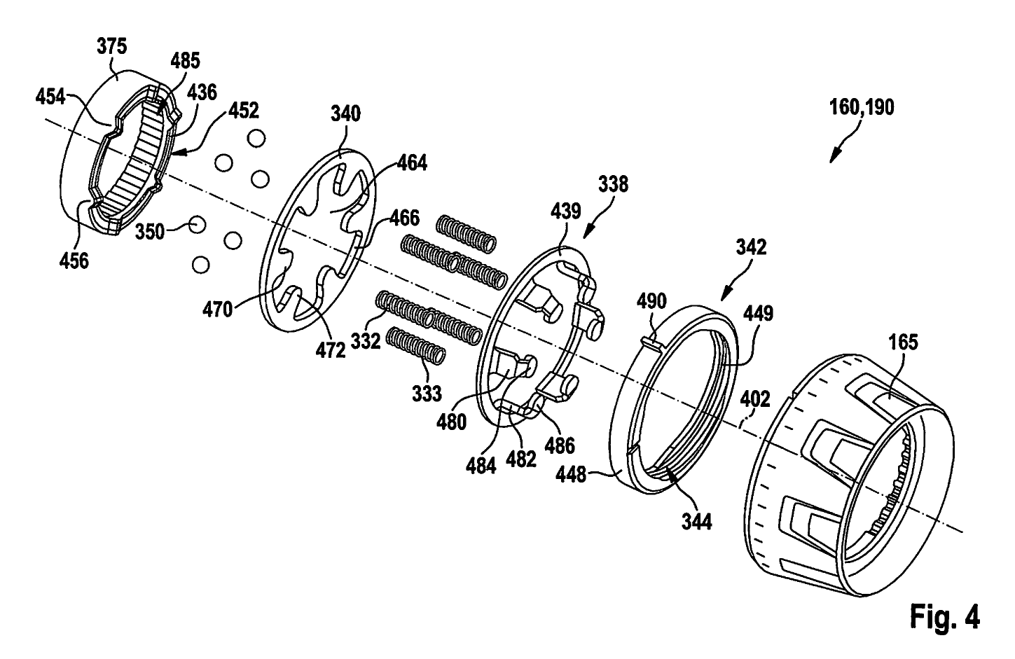

Preferably at least two and, more preferably, six detent members 350 are situated between transmission element 340 and a ring gear 375 assigned to front planetary stage 370. Only two detent members 350 are represented in FIG. 3. Due to the spring force applied by spring elements 332, 333 onto transmission element 340 in the axial direction, detent members 350 are preferably acted upon against a coupling geometry (452 in FIG. 4) formed on the front side of ring gear 375. Spring elements 332, 333 are preferably mounted at both ends between transmission element 340 and a spring element holder 338.

Torque adjustment sleeve 165 assigned to torque clutch 190 is preferably twistable, more preferably, however, at least essentially axially immovably situated on gear unit housing 175. A maximum torque which is transmissible by torque clutch 190 is adjusted by way of the user twisting torque adjustment sleeve 165, whereby spring element holder 338 is preferably displaceable in the axial direction of drive spindle 135 in order to vary the axial spring force of the at least one spring element 332.

Torque adjustment sleeve 165 is preferably rotatably fixedly coupled to an internal, nut-like adjustment ring 342, on which preferably at least one radially inwardly directed engagement element 344 is formed, which preferably engages with a male thread 382 provided on the outer circumference of gear unit housing 175. The thread-like connection between the at least one engagement element 344 and male thread 382 of gear unit housing 175 is preferably utilized for guiding adjustment ring 342 on male thread 382 by way of twisting torque adjustment sleeve 165 and, therefore, for effectuating a displacement of adjustment ring 342 in parallel to the longitudinal direction of drive spindle 135 and, as a result, for varying the spring force of spring elements 332, 333 within predefined limits.

As a result of the torque and speed conversion, a supporting torque occurs within planetary gear set 170, which is transmitted from the planet wheels of front planetary stage 370 to ring gear 375. Torque clutch 190 responds when the supporting torque becomes greater than an applied holding torque, and therefore ring gear 375 ultimately slips or spins. In this case, the transmission of speed between front planetary stage 370 of planetary gear set 170 and drive spindle 135 is interrupted or disabled and the transmission of torque is at least limited. The particular holding torque acting on ring gear 375 is dependent on the axial position of spring element holder 338 in this case and, therefore, on the rotation position of torque adjustment sleeve 165.

In the axial position of spring element holder 338 illustrated in FIG. 3, spring elements 332, 333 are largely relaxed, and therefore the at least one detent member 350 is acted upon by transmission element 340, with a comparatively low axial spring force, against the coupling geometry (452 in FIG. 4) of the front side of ring gear 375. As a result, ring gear 375 slips or rotates even at comparatively low torques acting on drive spindle 135 and hand-held power tool 100 is in a “screwing mode.”

If spring elements 332, 333 are tensioned or compressed by a greater extent, however, which is preferably achievable by way of the axial displacement of spring element holder 338 in the direction of planetary gear set 170 implemented by the user twisting torque adjustment sleeve 165, detent members 350 are acted upon by transmission element 340 with a higher spring force against ring gear 375, whereby a higher holding torque results, and therefore a slipping or spinning first occurs at higher torques acting on drive spindle 135. If spring elements 332, 333 are approximately completely compressed, detent members 350 are preferably acted upon by transmission element 340, against the coupling geometry (452 in FIG. 4) of ring gear 375, with an axial spring force which is so great that the ring gear may practically no longer slip and a “drilling mode” of the hand-held power tool is activated, in which a maximum working torque is tappable at drive spindle 135. It is pointed out that the mode of operation of a torque clutch is conventional, incidentally, in the field of combi drills, and therefore a more detailed description of the mode of operation of torque clutch 190 may be dispensed with here for the sake of conciseness of the description.

FIG. 4 shows a portion of cut-through 300 from FIG. 1 and FIG. 3. Essentially hollow-cylindrical ring gear 375 of torque clutch 190 therefore preferably includes internal toothing 485 and a coupling geometry 452 is formed on a front side 436 of ring gear 375. Coupling geometry 452 includes only six identical raised areas in this case, by way of example, the cross-sectional geometry of which approximately corresponds to that of an isosceles trapezoid, by way of example, and of which two raised areas 454, 456 are labeled, by way of example. The preferably six raised areas 454, 456, which are formed on the circumference and are uniformly spaced apart from each other, preferably face spherical detent members 350 in the axial direction, of which only one detent member 350 is labeled in this case as well in order to improve the clarity of the drawing.

The preferably at least essentially disk-shaped transmission element 340 preferably includes a central recess 464, on the inner edge 466 of which preferably six radially inwardly directed projections, each of which is approximately V-shaped, are formed, of which only two projections 470, 472 are labeled in order to improve the clarity of the drawing. The number of projections 470, 472 preferably corresponds to the number of spring elements 332, 333 utilized. Alternatively thereto, the number of projections 470, 472 corresponds to the number of detent members 350, for example when a single spring element is utilized, which is situated concentrically to drive spindle 135.

Each projection 470, 472 is preferably utilized, in this case, as a first support or abutment for one spring element in each case, of which only spring element 332 and spring element 333 are labeled in this case. According to one specific embodiment, spring elements 332, 333 are designed as compression springs. Spring element holder 338 is preferably a second support or abutment for spring elements 332, 333 in this case.

For this purpose, spring element holder 338 preferably includes an approximately circular ring-shaped base body 439, on the unlabeled inner edge of which, by way of example, six holding webs—of which only two holding webs 480, 482 are labeled—extending in parallel to a longitudinal central axis 402 of torque clutch 190 are formed in this case. Holding webs 480, 482 of spring element holder 338 are situated in the circumferential direction of spring element holder 338 preferably uniformly spaced apart from each other on the inner edge of spring element holder 338. Each holding web 480, 482 preferably includes, on its free end pointing in the direction of adjustment ring 342, a radially inwardly directed, approximately semicircular tab, of which two tabs 484, 486 are labeled. Tabs 484, 486 preferably function as a second support or abutment for one of the spring elements 332, 333, respectively. The number of tabs 484, 486 preferably corresponds to the number of utilized spring elements 332, 333.

With the aid of adjustment ring 342, the axial position of spring element holder 338 and, therefore, the maximum torque transmissible by torque clutch 190 up to the point of response is adjusted. Adjustment ring 342 preferably includes an approximately hollow-cylindrical base body 448 including an engagement element 344 which is formed on the inner circumference and is designed as a female thread 449 in this case, as demonstrated. A radially outwardly directed, rectangular driver 490 is located on the outer circumference of the adjustment ring for the rotatably fixed coupling of torque adjustment sleeve 165.

In deviation from the only six raised areas 454, 456 of coupling geometry 452 of ring gear 375 represented here, the six spherical detent members 350, the six radially inwardly directed tabs 484, 486 of transmission element 340, the six spring elements 332, 333, and the six projections 470, 472 or holding webs 480, 482 of spring element holder 338, a number of each of the aforementioned elements deviating from six may be provided.

FIG. 5 shows fan wheel 120 and drive motor 180 from FIG. 1 including motor electronics system 215 from FIG. 2. In this case, FIG. 5 illustrates drive motor 180, which is preferably designed as an electronically commutated drive motor, including a stator 512 and a rotor 514. Motor electronics system 215 is preferably situated in the area of bearing element 124, having been screwed onto the lateral face of stator 512 facing bearing element 124, as demonstrated.

FIG. 6 shows an exemplary arrangement of fan wheel 120 from FIG. 1 on drive shaft 182 of drive motor 180 from FIG. 1. Fan wheel 120 is formed as two pieces, including a flange 624 and an air guide member 622, as demonstrated. Flange 624 is preferably designed in this case to form a force-locked connection between drive shaft 182 and air guide member 622. Preferably, flange 624 and air guide member 622 are connected to each other via an arbitrary connection 627, for example a force-locked and/or form-fit connection, by way of example a press-fit connection.

Air guide member 622 is preferably designed as a disk, a plurality of air guide vanes 632, 634 being preferably situated on a side 621 facing drive motor 180. By way of example, two of the air guide vanes are labeled with a reference numeral 632, 634. In this case, flange 624 and air guide member 622 may preferably include different materials, for example a composite material which includes at least plastic or two different metals. In this case, as described above, preferably at least 20 percent by volume of fan wheel 120 includes a metal having a density which is greater than or equal to 3.5 g/cm³. Air guide member 622 preferably includes a zinc alloy and flange 624 is preferably formed as a steel bush.

In addition, fan wheel 120 may also be formed as one piece. In this case, fan wheel 120 may be designed as an injection molded part including a molding material which includes a metal having a density which is greater than or equal to 3.5 g/cm³. Fan wheel 120 is preferably designed as a hybrid fan which is preferably designed for drawing in air in the axial direction of fan wheel 120 or along an air-flow direction 604 and giving off air in the radial direction of fan wheel 120 or along an air-flow direction 602 and/or in the axial direction of fan wheel 120 or along an air-flow direction 606. Fan wheel 120 may also be designed as a radial fan or as a diagonal fan, however.

Moreover, FIG. 6 illustrates drive motor 180 from FIG. 1—which is preferably designed as an electronically commutated drive motor—including rotor 514 which preferably includes a laminated armature core preferably made of steel sheet and/or which is provided with at least one permanent magnet 612. The at least one permanent magnet 612 is preferably designed in the shape of a rod and/or preferably includes rare earth metal elements. Moreover, a spacer element 614, 613, 615 is provided between bearing element 122 and fan wheel 120, between fan wheel 120 and drive motor 180, and between drive motor 180 and bearing element 124, respectively, for the secure arrangement on drive shaft 182. In addition, fan wheel 120 preferably has an outer diameter D which is greater than or equal to an outer diameter d of rotor 514.

FIG. 7 shows hand-held power tool 100 from FIG. 1, which, according to yet another specific embodiment, is designed in the manner of a rotary impact screwdriver 700. Rotary impact screwdriver 700 includes spring detent mechanism 160 from FIG. 1 which, in this case, is preferably designed in the manner of a rotary impact mechanism 730, preferably as a V-groove rotary impact mechanism. Rotary impact mechanism 730 is designed, in this case, at least for implementing a rotary impact mode.

In this case, drive motor 180 is connected via drive shaft 182 to gear unit 170 which preferably converts a rotation of drive shaft 182 into a rotation of an intermediate shaft 740 provided between gear unit 170 and rotary impact mechanism 730. Mechanical rotary impact mechanism 730, which is connected to intermediate shaft 740, includes a spring-loaded impact body 734 which carries out impact-like angular momentum with high intensity and transmits the angular momentum via an output cam system to an output member 732, for example an output spindle. In this case, at least one, as demonstrated, two drive elements 750 are assigned to intermediate shaft 740. Drive elements 750 are preferably designed as drive balls.

Impact body 734 is coupled to intermediate shaft 740 via drive elements 750, so that intermediate shaft 740, which is driven by drive motor 180 via planetary gear set 170, sets impact body 734 into rotary motion. Simultaneously, impact body 734 is preferably axially movably mounted on intermediate shaft 740. In the non-percussive drive mode, impact body 734 is preferably preloaded by way of a spring element 733 in the direction of output spindle 735. In this case, suitable drive cams preferably act on assigned output cams in such a way that the rotary motion of impact body 734 is transmitted to output spindle 735. As demonstrated, output member 732 is coupled to an output spindle 735, output spindle 735 being designed for accommodating an insertion tool. In the rotary impact mode, drive elements 750 move impact body 734—preferably with the aid of a suitable V-groove of intermediate shaft 740—in the direction of drive motor 180 and, therefore, spring element 733 is compressed. Thereupon, drive elements 750 are decoupled from intermediate shaft 740 and impact body 734 hurtles, accelerated by spring element 733, in the direction of the tool holder (140 in FIG. 1). In its front end position, the corresponding V-groove catches drive elements 750 again and moves impact body 734 again in the direction of drive motor 180. Moreover, the mode of operation and the design of a suitable rotary impact mechanism are conventional and, therefore, are not described further, for the sake of conciseness of the description.

In addition, FIG. 7 illustrates one further arrangement of fan wheel 120, in which fan wheel 120 is situated between drive motor 180 and gear unit 170. Due to the arrangement of fan wheel 120 shown, a speed drop in the impact drilling mode may therefore be at least reduced, as described above. As demonstrated, motor electronics system 215 from FIG. 2 is situated, in this case, on the side of drive motor 180 assigned to bearing element 122 or on a side of drive motor 180 facing away from gear unit 170.

It is pointed out that fan wheel 120 may also be situated in rotary impact screwdriver 700 on the side of drive motor 180 facing away from gear unit 170. Combi drill 200 from FIG. 2 may therefore also have the arrangement of fan wheel 120 between drive motor 180 and gear unit 170.

What is claimed is:

1. A hand-held power tool, comprising:
a tool housing in which a drive motor is situated for driving a drive spindle provided with a tool holder, the tool holder being designed for accommodating an insertion tool;
a spring detent mechanism which is assigned to the drive spindle and includes at least one spring element, the at least one spring element being compressible, in at least one operating mode of the hand-held power tool, at least in phases, with the aid of energy of the drive motor; and
a fan wheel to cool the drive motor, at least 20 percent by volume of the fan wheel including a metal having a density which is greater than or equal to 3.5 g/cm³.

2. The hand-held power tool as recited in claim 1, wherein the fan wheel includes at least one of zinc, a zinc alloy, brass, and steel.

3. The hand-held power tool as recited in claim 1, wherein the fan wheel includes a flange for forming a force-locked connection to a drive shaft assigned to the drive motor.

4. The hand-held power tool as recited in claim 3, wherein the fan wheel includes a composite material which includes at least one of plastic or two different metals.

5. The hand-held power tool as recited in claim 1, wherein a gear unit is situated between the drive motor and the tool holder, the gear unit being designed in the manner of a planetary gear set and having at least one planetary stage.

6. The hand-held power tool as recited in claim 5, wherein the at least one planetary stage includes at least one sun wheel and one ring gear, the sun wheel being movable in the radial direction of the gear unit by at least 0.2 mm relative to the ring gear.

7. The hand-held power tool as recited in claim 1, wherein the spring detent mechanism is situated between the gear unit and the tool holder.

8. The hand-held power tool as recited in claim 1, wherein the spring detent mechanism is one of a torque clutch or a rotary impact mechanism.

9. The hand-held power tool as recited in claim 1, wherein the drive motor is designed in the manner of an electronically commutated drive motor including a stator and a rotor provided with at least one permanent magnet.

10. The hand-held power tool as recited in claim 1, wherein the fan wheel has an outer diameter which is greater than or equal to an outer diameter of the drive motor.

11. The hand-held power tool as recited in claim 1, wherein the hand-held power tool is one of a combi drill or a rotary impact screwdriver.
